(19) United States
(12) Patent Application Publication
(10) Pub. No.: US 2011/0224121 A1
(43) Pub. Date: Sep. 15, 2011

(54) NONIONIC SURFACTANT BLENDS USING SEED OILS

(76) Inventors: Pierre T. Varineau, Lake Jackson, TX (US); Mark F. Sonnenschein, Midland, MI (US)

(21) Appl. No.: 13/123,064

(22) PCT Filed: Oct. 6, 2009
(86) PCT No.: PCT/US09/59614

§ 371 Date: May 23, 2011

Related U.S. Application Data
(60) Provisional application No. 61/103,255, filed on Oct. 7, 2008.

(51) Int. Cl. C11D 1/825

(52) U.S. Cl. 510/360; 510/535

(57) ABSTRACT

Described are nonionic surfactant blends comprising the transesterification product of poly(ethylene glycol), preferably methoxy-poly(ethylene glycol), and a seed oil, such as castor oil, soybean oil, olive oil, palm oil, palm kernel oil, peanut oil, rapeseed oil, corn oil, sesame seed oil, cottonseed oil, canola oil, safflower oil, linseed oil, coconut oil, or sunflower oil, or blends thereof.

### CROSS REFERENCE TO RELATED APPLICATIONS

This application claims the benefit of U.S. Provisional Application No. 61/103,255, filed on Oct. 7, 2008.

### FIELD

The present application relates generally to surfactants and methods of manufacture of the same.

### BACKGROUND

Nonionic surfactant blends incorporating fatty acid methyl ester ethoxylates (MEE) have been roundly praised for their biodegradation and low toxicity, as well as their performance. For example, their performance is similar to the widely used primary alcohol ethoxylates, as shown in “Rapeseed Methyl Ester Ethoxylates: A New Class of Surfactants of Environmental and Commercial Interest” M. Renkin Et. al. Tenside Surf. Det 42 (2005) 5. However, they have not been as widely adopted in the surfactant market, for example, laundry detergents, perhaps due to manufacturing costs.

Current methods for producing MEE rely in the use of a special catalyst for the direct ethoxylation of fatty acid methyl esters (as shown in U.S. Pat. No. 5,191,104 by King) or by transesterification of fatty acid methyl esters with poly(ethylene glycol) methyl ether (as shown in U.S. Pat. No. 6,849,751). Both methods produce high-purity MEE, but result in a product that does not have a significant cost benefit over conventional alcohol ethoxylates. Thus, what is needed are new processes capable of producing methyl ester ethoxylates at a significantly reduced cost, thus, creating more widespread usage of these materials.

### SUMMARY

In one embodiment, the present invention provides nonionic surfactant blends, comprising the transesterification products of poly(ethylene glycol) and a seed oil. The nonionic surfactant blends comprise fatty acid esters of polyethylene glycol, di-esters of fatty acids and poly(ethylene glycol), mono and di-glycerides, glycerol, and fatty acid.

In a preferred embodiment, the present invention provides a nonionic surfactant blend, comprising the transesterification product of methoxy-poly(ethylene glycol) and a seed oil. The nonionic surfactant blend comprises methyl ester ethoxylates of fatty acids, mono and di-glycerides, glycerol, and fatty acid.

The present invention in one embodiment also provides a low-cost process based on the direct transesterification of seed oil, rather than purified fatty acid methyl ester, with methoxy poly(ethylene glycol), that produces a complex surfactant blend with laundry performance properties similar to purified MEE.

### DETAILED DESCRIPTION

In one embodiment, the present invention provides nonionic surfactant blends, comprising the transesterification products of poly(ethylene glycol) and a seed oil. The nonionic surfactant blends comprise fatty acid esters of polyethylene glycol, di-esters of fatty acids and poly(ethylene glycol), mono and di-glycerides, glycerol, and fatty acid.

In a preferred embodiment, the present invention provides a nonionic surfactant blend, comprising the transesterification product of methoxy-poly(ethylene glycol) and a seed oil. The nonionic surfactant blend comprises methyl ester ethoxylates of fatty acids, mono and di-glycerides, glycerol, and fatty acid.

The term “transesterification product” is intended to convey that surfactants of the present invention are produced by direct transesterification of raw seed oils with the glycol, without having to rely on purified raw materials such as fatty acid methyl esters. Thus, the present invention utilizes all components of seed oil, and reduces processing steps.

For example, as mentioned above, the prior art process for making methyl ester ethoxylates (MEE) involves the transesterification of purified fatty acid methyl esters with methoxy(polyethylene glycol) in the absence of glycerol or the direct ethoxylation of fatty acid methyl esters using special ethoxylation catalysis. Both techniques rely on the use of purified fatty acid methyl ester, which is produced via transesterification of seed oil with methanol, followed by separation and removal of glycerol. Post-production steps, in which the fatty acid methyl ester is distilled or fractionated are commonly used to further purify the material. Accordingly, the existing process for producing methyl ester ethoxylates consists of 1) transesterifying seed oil with methanol to produce fatty acid methyl ester plus glycerol, 2) removal of glycerol, 3) distillation of fatty acid methyl esters to form purified cuts, and 4) direct ethoxylation of fatty acid methyl esters or transesterification of fatty acid methyl esters with methoxy poly(ethylene glycol).

In contrast, in one embodiment, the present invention includes a 1-step process for the production of MEE which comprises a transesterification of seed oil with methoxy poly(ethylene glycol) with no prior purification of fatty acid methyl esters or no post-production purification of MEE. The resulting nonionic surfactant blend contains all of the original glycerol, contained as a complex blend of free glycerol, monoglycerides, diglycerides, and triglycerides, as well as MEE from the transesterification of methoxy poly(ethylene glycol) with the seed oil. Thus, Applicants have surprisingly found that a complex blend of methyl ester ethoxylates, produced by the direct transesterification of seed oil with methoxy poly(ethylene glycol) produced a surfactant blend that has performance properties very similar to purified methyl ester ethoxylates.

In one embodiment, the ratio of methoxy-poly(ethylene glycol) to seed oil is from about 1:10 to about 10:1, preferably about 1:3 to about 3:1. In a ratio of 10 moles methoxy(polyethylene glycol) to 1 mole of seed oil, the amount of glycerol (contained as free glycerol, or as the mono, di, or triglycerides) is approximately 1.0 wt. %. A 1:1 ratio methoxy(polyethylene glycol):seed oil, corresponds to about 5 wt. % glycerol (contained as free glycerol, or as the mono, di, or triglycerides) A 1:10 ratio methoxy(polyethylene glycol):seed oil, corresponds to about 10 wt. % glycerol (contained as free glycerol, or as the mono, di, or triglycerides). All of these estimates assume the use of a poly(ethylene glycol) or methoxy poly(ethylene glycol) with a molecular weight of 1000.

The molecular weight of the methoxy-poly(ethylene glycol) is about 100 to about 2000, preferably about 500 to about 1500, more preferably about 700 to about 1300.

A typical seed oil is soybean oil, which consists of triglycerides of the following fatty acids (by approximate weight percent): 7-11% palmitic, 2-6% stearic, 15-33% oleic, 43-56 linoleic and 5-11% linolenic acids. This corresponds to an approximate weight percent of glycerol of 10%, contained in soybean oil as triglycerides. For every 100 grams of soybean oil converted to fatty acid methyl ester, approximately 10 grams of glycerol is produced.

The seed oil is at least one of castor oil, soybean oil, olive oil, palm oil, palm kernel oil, peanut oil, rapeseed oil, corn oil, sesame seed oil, cottonseed oil, canola oil, safflower oil, linseed oil, coconut oil, or sunflower oil, or blends thereof. The seed oil may be either hydrogenated or partially hydrogenated.

In one embodiment, nonionic surfactant blends of the present invention find use in laundry detergent. Additional conventional laundry detergent additives, such as additional surfactants, builders, foaming agents, suds control agents, enzymes, fabric softeners, anti-redeposition agents, corrosion inhibitors, whitening agents, bleaches, processing aids, dyes and/or fragrances in suitable amounts known to those skilled in the art are contemplated. One conventional detergent base to which surfactant can be added includes the sodium salt of dodecyl benzene sulfonic acid, citric acid, sodium tetraborate, calcium chloride, water, propylene glycol, ethanol, triethanolamine, and proteolytic enzyme.

In another embodiment, nonionic surfactant blends of the present invention find use as surfactants in general; as low foam surfactants for household and commercial cleaning; as low foam surfactants in mechanical cleaning processes, as reactive diluents in casting, encapsulation, flooring, potting, adhesives, laminates, reinforced plastics, and filament windings; as coatings; as wetting agents; as rinse aids; as defoam/low foam agents; as spray cleaning agents; as emulsifiers for herbicides and pesticides; as metal cleaning agents; as suspension aids and emulsifiers for paints and coatings; as mixing enhancers in preparing microheterogeneous mixtures of organic compounds in polar and non-polar carrier fluids for agricultural spread and crop growth agents; as stabilizing agents for latexes; as microemulsifiers for pulp and paper products; and the like. In one non-limiting embodiment, compositions utilizing the MEE may include microemulsions used for organic synthesis, formation of inorganic and organic particles, polymerization, and bio-organic processing and synthesis, as well as combinations thereof. In other non-limiting embodiments, the MEE described herein may serve to dilute higher viscosity epoxy resins based on, for example, bisphenol-A, bisphenol-F, and novolak, as well as other thermoplastic and thermoset polymers, such as polyurethanes and acrylics. They may also find use in rheology modification of liquid systems such as inks, emulsions, paints, and pigment suspensions, where they may also be used to impart, for example, enhanced biodegradability, pseudoplasticity or thixotropic flow behavior. In these and other uses the MEE may offer good and, in some cases, excellent performance, as well as relatively low cost.

In one embodiment, the present invention provides methods of producing a nonionic surfactant blend, comprising combining methoxy-poly(ethylene glycol) and a seed oil to form a mixture, adding an esterification catalyst to the mixture, inducing the system to undergo transesterification and then neutralizing the mixture, thereby affording a nonionic surfactant blend. The blend comprises methyl ester ethoxylates, mono and di-glycerides, glycerol, and fatty acid. Generally, a preferred range for the ratio of methoxy-poly(ethylene glycol) to seed oil is from about 1:10 to about 10:1, preferably about 1:3 to about 3:1.

In one embodiment, the molecular weight of the methoxy-poly(ethylene glycol) is about 100 to about 2000, preferably about 500 to about 1500, more preferably about 700 to about 1300. Preferably, the seed oil is at least one of castor oil, soybean oil, olive oil, palm oil, palm kernel oil, peanut oil, rapeseed oil, corn oil, sesame seed oil, cottonseed oil, canola oil, safflower oil, linseed oil, coconut oil, or sunflower oil, or blends thereof.

The catalyst can be any homogeneous or heterogeneous transesterification catalyst known to those skilled in the art. Typically, the catalyst will be a metal alkoxide, such as sodium or potassium hydroxide or a heterogeneous catalyst, such as Zeolite or phosphate, as outlined in U.S. Pat. No. 6,407,269. In one embodiment, the esterification catalyst is about 0.1% sodium hydroxide by weight. In this embodiment, the step of neutralizing further comprises adding acetic acid. If base catalysts are used, any form of neutralization or catalyst removal known by those skilled in the art may be used, including ion-exchange. For heterogeneous esterification or transesterification catalysts, the catalyst may be left in the system, or removed by any technique known by those skilled in the art.

The method may optionally further comprise heating the mixture after addition of the esterification catalyst, with or without the presence of a vacuum. Preferably, the temperature is raised to about 200° C. The method may optionally further comprise cooling the mixture before neutralizing or removing the catalyst.

### EXAMPLES

The following examples are for illustrative purposes only and are not intended to limit the scope of the present invention. All percentages are by weight unless otherwise specified.

### Example 1

Exemplary nonionic surfactant blends of the present invention contain the components recited in TABLE 1.

TABLE 1

| | 10% Methanolic | | | |
|---|---|---|---|---|
| | Potassium | | Palm Kernel | |
| Batch | Methoxide | Soybean Oil | Oil | MPEG 1000 |
| 1 | 2.5 | 100.03 | | 300 |
| 2 | 2.51 | 100.02 | | 200.05 |
| 3 | 2.51 | 100.04 | | 100.02 |
| 4 | 2.5 | | 102.47 | 300.16 |
| 5 | 2.51 | | 100.05 | 200.54 |
| 6 | 2.53 | | 100.04 | 100.04 |

As an esterification catalyst, an alcoholic potassium methoxide solution is prepared by mixing 10 grams of 96% potassium methoxide, 95% (Aldrich 292788) to 90 grams anhydrous methanol under nitrogen.

In a 500 mL round bottom flask, the amounts recited in TABLE 1, in grams, above, of esterification catalyst (prepared above), seed oil, polyethylene glycol methyl ether (MPEG 1000) (molecular weight 1000, obtained from The Dow Chemical Company) and 0.2 grams sodium borohydride. The mixture is purged with nitrogen, with stirring, for about 11 minutes, and then heated to about 50° C. A vacuum is placed over the solution, initially at 100 mm Hg, and then ramped down to 2 mm Hg, until no visible boiling occurs (about 35 minutes). Under a nitrogen purge, with stirring, the mixture is heated to 150° C., and allowed to react for about 7 hours. The material is subsequently cooled to about 50° C., and neutralized with approximately 10 drops of glacial acetic acid.

### Example 2 (Comparative)

Exemplary comparative purified methyl ester ethoxylates were procured from commercial sources:
C₁₂(EO)₉—OCH₃=MEE 12-9
C₁₆-C₁₈(EO)₁₂—OCH₃=MEE 168-12
C₁₂(EO)₁₂—OCH₃=MEE 12-12
C₁₈:1(EO)₉—OCH₃=MEE 181-12
   MEE 12-9 is a methyl ester ethoxylate with 9 moles of ethylene oxide, based on a fatty acid methyl ester with 12 carbons. MEE 168-12 is a methyl ester ethoxylate with 12 moles of ethylene oxide, based on a fatty acid methyl ester with 16-18 carbons. MEE 12-12 is a methyl ester ethoxylate with 12 moles of ethylene oxide, based on a fatty acid methyl ester with 12 carbon atoms. MEE 181-112 is a methyl ester ethoxylate with 12 moles of ethylene oxide, based on a fatty acid methyl ester with 18 carbon atoms (and 1 degree of unsaturation).

### Example 3

Formulations made substantially according to the protocol described in Example 1 were made and tested against the comparative compositions described in Example 2.

Reflectance values were obtained from laundry testing of standard Sebum-stained swatches before and after cleaning, and the average difference, “delta reflectance” is reported below. Higher values of delta reflectance correlate to better cleaning.

The results are recited in TABLE 2 as delta reflectance units (measured via Hunter Colorimeter):

TABLE 2

| | | Lower 95% | Upper 95% |
|---|---|---|---|
| | Average | Confidence Interval | Confidence Interval |
| Batch 1 | 1.43 | 1.19 | 1.68 |
| Batch 2 | 1.32 | 1.00 | 1.63 |
| Batch 3 | 1.31 | 1.00 | 1.62 |
| Batch 4 | 1.11 | 0.82 | 1.40 |
| Batch 5 | 1.08 | 0.88 | 1.28 |
| Batch 6 | −0.10 | −0.35 | 0.15 |
| Comparative | 1.63 | 1.32 | 1.94 |
| MEE 12-9 | | | |
| Comparative | 1.61 | 1.31 | 1.91 |
| MEE 168-12 | | | |
| Comparative | 2.05 | 1.70 | 2.40 |
| MEE 12-12 | | | |
| Comparative | 2.01 | 1.66 | 2.37 |
| MEE 181-12 | | | |

The delta reflectance of water was −0.98 (lower 95% confidence interval: −1.27; upper 95% confidence interval: −0.69). Based on overlap of confidence intervals, there is no statistical difference between Batches 1-3, MEE 12-9, and MEE 168-12, showing that surfactant blends based on unpurified seed oil are as effective in cleaning as purified methyl ester ethoxylates. Batch 6 represents a non-optimum weight (1:1) ratio, of the transesterification of MPEG 1000 with palm kernel oil, which demonstrates that correct ratios of MPEG to seed oil are critical in producing effective MEE blends.

The method for the evaluation of the detergency of methyl ester ethoxylates is discussed in Tenside. Surf. Det. 42 (2005) 5 “Rapeseed Methyl Ester Ethoxylates: A New Class of Surfactants of Environmental and Commercial Interest” M Renkin, S. Fleurackers, I. Szwach, M. Hreczuch. Within this reference, it is noted that Sebum soils are an ideal soil for the evaluation of nonionic surfactants and methyl ester ethoxylates. The fabric swatches were STC EMPA 119 Cotton/Polyester with Sebum/Carbon, Testfabrics, Inc. Lot 3-1. The wash formulation was 200 ppm nonionic surfactant (from TABLE 2), 700 ppm synthetic “detergent base” consisting of the following: 15 parts dodecyl benzene sulfonic acid, sodium salt, 3 parts citric acid, 2 parts sodium tetraborate, 0.1 part calcium chloride, 45 parts water, 12 parts propylene glycol, 3 parts ethanol, 29.2 parts triethanolamine, and 0.5 parts proteolytic enzyme (Alkalase™). The laundry conditions were 100 cycles/min, 100° F.; 12 minute wash, 2 minute rinse, 150 ppm water hardness.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each patent, patent application, and publication cited or described in this document are hereby incorporated herein by reference, in their entireties.

1. A nonionic surfactant blend, comprising:
the transesterification product of methoxy-poly(ethylene glycol) and a seed oil.

2. The nonionic surfactant blend of claim 1, wherein the nonionic surfactant blend comprises methyl ester ethoxylates of fatty acids, mono and di-glycerides, glycerol, and fatty acid.

3. The nonionic surfactant blend of claim 1, wherein the nonionic surfactant blend contains at least 0.50 glycerol by weight percent (contained as free glycerol, or as the mono, di- or triglycerides).

4. The nonionic surfactant blend of claim 1, wherein the ratio of methoxy-poly(ethylene glycol) to seed oil is from about 1:10 to about 10:1, preferably about 1:3 to about 3:1.

5. The nonionic surfactant blend of claim 1, wherein the molecular weight of the methoxy-poly(ethylene glycol) is about 100 to about 2000, preferably about 500 to about 1500, more preferably about 700 to about 1300.

6. The nonionic surfactant blend of claim 1, wherein the seed oil is at least one of castor oil, soybean oil, olive oil, palm oil, palm kernel oil, peanut oil, rapeseed oil, corn oil, sesame seed oil, cottonseed oil, canola oil, safflower oil, linseed oil, coconut oil, or sunflower oil, or blends thereof.

7. The nonionic surfactant blend of claim 6, wherein the seed oil is soybean oil.

8. The nonionic surfactant blend of claim 6, wherein the seed oil is hydrogenated or partially hydrogenated.

9. A laundry detergent including the composition of claim 1.

10. A cleaning composition including the composition of claim 1.

11. A method of producing a nonionic surfactant blend, comprising:
combining methoxy-poly(ethylene glycol) and a seed oil to form a mixture,
adding an esterification catalyst to the mixture, and
then neutralizing the mixture, thereby affording a nonionic surfactant blend.

12. The method of claim 11, wherein the nonionic surfactant blend comprises methyl ester ethoxylates, mono and di-glycerides, glycerol, and fatty acid.

13. The method of claim 11, wherein the ratio of methoxy-poly(ethylene glycol) to seed oil is from about 1:10 to about 10:1, preferably about 1:3 to about 3:1.

14. The method of claim 11, wherein the molecular weight of the methoxy-poly(ethylene glycol) is about 100 to about 2000, preferably about 500 to about 1500, more preferably about 700 to about 1300.

15. The method of claim 11, wherein the seed oil is at least one of castor oil, soybean oil, olive oil, palm oil, palm kernel oil, peanut oil, rapeseed oil, corn oil, sesame seed oil, cottonseed oil, canola oil, safflower oil, linseed oil, coconut oil, or sunflower oil, or blends thereof.

16. The method of claim 11, wherein the esterification catalyst is about 0.1% sodium hydroxide by weight.

17. The method of claim 11, wherein the step of neutralizing further comprises adding acetic acid.

18. The method of claim 11, further comprising heating the mixture after addition of the esterification catalyst.

19. The method of claim 18, wherein the temperature is raised to about 200° C.

20. The method of claim 11, further comprising cooling the mixture before neutralizing.

21. (canceled)

22. (canceled)
